(19) United States
(12) Patent Application Publication
(10) Pub. No.: US 2011/0013968 A1
(43) Pub. Date: Jan. 20, 2011

(54) FLUID APPLICATOR ASSEMBLY

(76) Inventors: Shawn Donegan, Lakewood, OH (US); Charles Thur, Broadview Heights, OH (US); Mark Cipolla, Chardon, OH (US); Paul Stephens, Twinsburg, OH (US)

Correspondence Address: FAY SHARPE LLP, 1228 Euclid Avenue, 5th Floor, The Halle Building, Cleveland, OH, 44115, US

(21) Appl. No.: 12/300,050

(22) PCT Filed: May 8, 2007
(86) PCT No.: PCT/US07/68461

§ 371 Date: May 26, 2009

Related U.S. Application Data
(60) Provisional application No. 60/798,531, filed on May 8, 2006.

(51) Int. Cl. B05C 21/00

(52) U.S. Cl. 401/219

(57) ABSTRACT

A fluid applicator assembly includes an applicator device and a pumping device. In one embodiment, the applicator device includes a frame, a fluid supply passage connected with the frame, and a handle connected to the frame. The frame includes a first roller mount in a first roller axis and a second roller mount in a second roller axis that is spaced from the first roller axis. The fluid supply passage connects with the frame and includes a fluid outlet arranged for dispensing fluid onto an external surface of at least one of the first and second rollers. The handle connects to the frame and is rotatable with respect to the frame and a handle pivot axis that is offset from the first roller axis and the second roller axis. The pumping device, in a housing in a pump disposed in the housing and in communication with the fluid supply passage.

### BACKGROUND OF THE INVENTION

Mechanical paint application assemblies typically include a paint applicator, a pump and tubing that extends from a paint container to the pump and further to the paint applicator. When the paint applicator is a roller type assembly, typically the paint applicator includes an internally fed roller. The internally fed roller is similar to a conventional cylindrical paint roller; however, the roller is configured to allow paint to be delivered from inside the roller and travel through passages in the roller to an outer surface of the roller. This construction makes these rollers more expensive than conventional rollers. Additionally, the paint delivery path through the applicator to the internally fed roller requires complicated seals or the paint delivery path is likely to leak resulting in paint being found at connections along the paint delivery path. Complicated seals are required because for the paint to be pushed from an inner surface of the roller to an outer surface requires a great amount of pressure. Moreover, the openings allowing paint to travel from the inner surface to the outer surface of the roller can become blocked. These internally fed roller assemblies are also not easily convertible for use with other paint or fluid applicators, such as cloth or foam pads, brushes and the like.

### SUMMARY OF THE INVENTION

A fluid applicator assembly includes an applicator device and a pumping device. In one embodiment, the applicator device includes a frame, a fluid supply passage connected with the frame, and a handle connected to the frame. The frame includes a first roller mount in a first roller axis and a second roller mount in a second roller axis that is spaced from the first roller axis. The fluid supply passage connects with the frame and includes a fluid outlet arranged for dispensing fluid onto an external surface of at least one of the first and second rollers. The handle connects to the frame and is rotatable with respect to the frame in a handle pivot axis that is offset from the first roller axis and the second roller axis. The pumping device includes a housing and a pump disposed in the housing and in communication with the fluid supply passage.

In another embodiment, the applicator device includes a fluid applicator tool including at least one of a roller, a brush and a pad. The applicator device also includes a fluid supply passage for dispensing fluid onto an application surface of the fluid applicator tool. The pumping device includes a pump, an electric reversible motor, a power supply and a polarity switch. The polarity switch is in electrical communication with the motor and the power supply for reversing the polarity of electricity provided to the motor which allows the pump to be operated in a first operating state where fluid is delivered to the fluid supply passage and in a second operating state where fluid is drawn away from the fluid supply passage.

In another embodiment, an applicator device and a pumping device are interconnected by a fluid path assembly. The fluid path assembly provides a fluid path between the applicator device and an associated fluid reservoir that is in fluid communication with the pumping device via the fluid path assembly. The applicator device includes a fluid applicator tool including at least one of a roller, a brush and a pad. The applicator device also includes a fluid supply passage having a plurality of openings for dispensing fluid onto an application surface of the fluid applicator tool. The pumping device includes a housing and a pump disposed in the housing. The fluid path assembly includes at least one hollow flexible tube connected to the fluid supply passage and the entire fluid path assembly is removable from the applicator device and the pumping device between the fluid supply passage and the associated reservoir.

### BRIEF DESCRIPTION OF THE FIGURES

FIG. 1 is a perspective view of a fluid applicator assembly.

FIG. 2 is a perspective view of an applicator device of the fluid applicator assembly.

FIG. 3 is a schematic depiction of the fluid applicator device depicted in FIG. 2.

FIG. 4 is a cross-sectional view taken along line 4-4 in FIG. 6.

FIG. 5 is a schematic depiction of a pumping device of the fluid applicator assembly depicted in FIG. 1.

FIG. 6 is a side view of the fluid applicator device depicted in FIG. 1.

FIG. 7 is a cross-sectional view taken along line 7-7 in FIG. 6.

FIG. 8 is a front view of the fluid applicator assembly depicted in FIG. 1.

FIG. 9 is a cross-sectional, partially schematic, view of an alternative embodiment of a fluid applicator that can be used with the pumping device depicted in FIG. 1.

### DETAILED DESCRIPTION

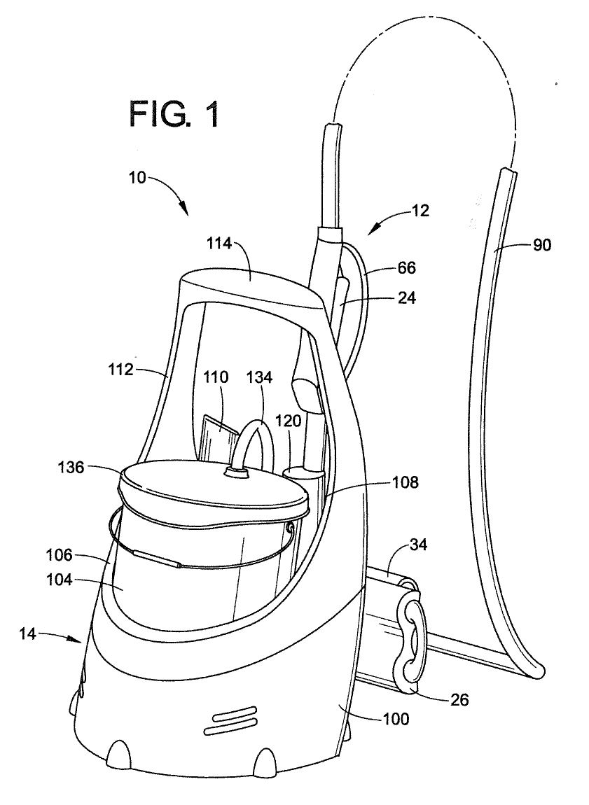

With reference to FIG. 1, a fluid applicator assembly 10 includes an applicator device 12 and a pumping device 14. The fluid applicator assembly 10 delivers fluid or liquid (which can include solids), including, but not limited to, paint, stain, primer, sealant, cleaner, adhesive, pesticides, herbicide, epoxies, etc. that are to be distributed on a surface. The pressure at which the fluid is under in the fluid applicator assembly can be much less than known fluid applicators that supply paint to an internally fed roller. Typically in the depicted embodiment, the paint or liquid is delivered as measured by gallons (or liters) per minute, and the pressure at which the paint or liquid is delivered is determined by the characteristics of the paint or liquid and the path through which it travels. Delivering the paint or liquid at lower pressures allows the fluid lines and other fittings along the fluid delivery path to have larger diameters and also reduces the stress of the components, e.g. fittings and hoses, along the fluid delivery path. A low pressure fluid delivery also limits fatigue to the operator because lighter materials can be used along the fluid delivery path.

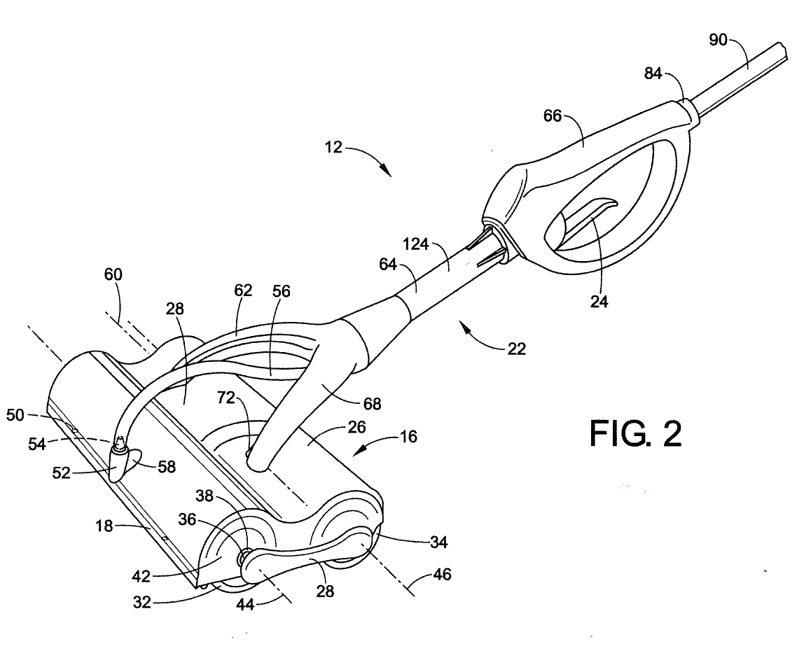

With reference to FIG. 2, the applicator device 12 generally includes a frame 16, a fluid supply tube 18, a handle 22, and a trigger 24. The frame 16 includes a splatter shield 26 having a central raised portion 28 where the handle 22 attaches to the splatter shield. The frame 16 also includes roller mounting bars 28 (only one visible in FIG. 2—the other roller mounting bar being on the opposite side of the splatter shield 26) for attaching a first (upper) roller 32 and a second (lower) roller 34 to the frame 16. The splatter shield 26 is contoured to generally follow the cylindrical shape of the rollers 32 and 34. The splatter shield 26 surrounds a majority of the cylindrical outer (application) surface of each roller 32, 34 as well as a majority of each circular end of the rollers. This prevents the rollers 32, 34 from accidental contact with surfaces, such as a ceiling or a floor, during a painting operation.

The rollers 32 and 34 are conventional paint rollers that are not internally fed. Each roller mounting bar 28 includes posts 36 (only one visible in FIG. 2—upper and lower roller mounts are provided on each roller mounting bar) to provide roller mounts. Each post 36 fits into a respective opening 38 (only one visible in FIG. 2) formed in a circular end cover 42 on each end of a respective roller 32, 34. The roller mounts, i.e. posts 36, on opposite sides of the splatter shield 26 are aligned, e.g. coaxial, with one another so that the first roller 32 rotates about a first roller axis 44 and the second roller 32 rotates about a second roller axis 46. The first roller axis 44 is spaced from the second roller axis 46 in a direction perpendicular to each of the roller axes. At least one of the roller mounting bars 28 is biased inwardly towards the splatter shield 26 by a spring (not visible) and is movable with respect to the splatter shield so that the roller mounting bar 28 can be moved away from the splatter shield 26 to remove the rollers 32 and 34 from the frame 16.

In addition to rollers, other fluid applicators and fluid distribution devices, such as foam pad, brushes, and the like, can attach to the roller mounts. Since the fluid applicator assembly includes externally fed applicators, the types of fluid applicators that can be used with the fluid applicator assembly are nearly limitless, especially as compared to an internally fed roller assembly.

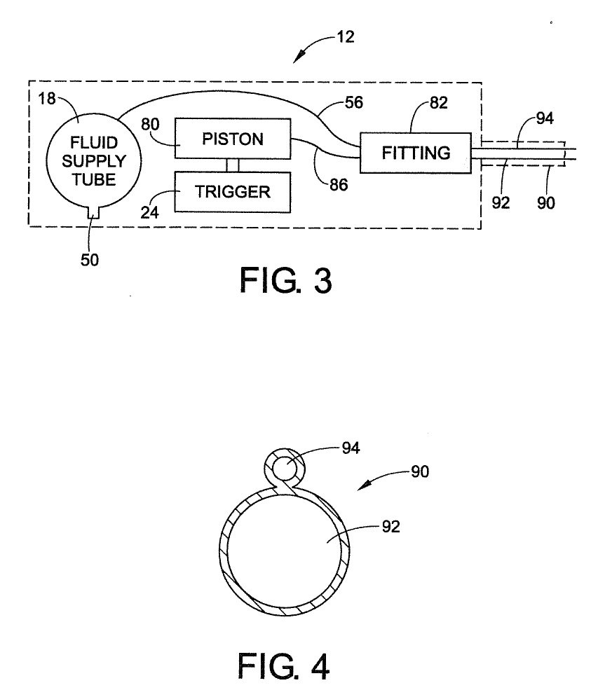

The fluid supply tube 18 connects to the splatter shield 26 and is in fluid communication with the pumping device 14 in a manner that will be described in more detail below. The fluid supply tube 18 can selectively latch with the splatter shield 26 to allow the fluid supply tube 18 to be easily removed from the splatter shield 26. For example, the splatter shield 26 can include notches that can receive appropriately shaped engagement mechanisms formed on an external surface of the fluid supply tube. The fluid supply tube 18 is hollow to define a fluid supply passage through which fluid flows to be deposited on an exterior surface of the upper roller 32. The fluid supply tube includes at least one fluid outlet 50 (shown in phantom in FIG. 2, see also FIG. 3) that is arranged with respect to the upper roller 32 for dispensing fluid onto the external surface of the upper roller. The fluid supply tube 18 is spaced a predetermined distance from the exterior surface of the upper roller 32 to allow the upper roller to rotate in the first roller axis 44. The clearance between the exterior surface of the upper roller 32 and the fluid supply tube 18 can be minimized so that the exterior surface of the upper roller contacts or nearly contacts (e.g. a clearance less than ¼″) the fluid supply tube 18, while still allowing the upper roller to rotate. This configuration can be desirable when the fluid applicator is used to apply fluid onto a ceiling.

If desired, the fluid supply tube 18 can be adjusted so that fluid is applied directly onto the surface upon which the rollers are working, for example a floor surface. The fluid supply tube 18 also includes a central hollow portion 52 that terminates in a press-on fitting 54 each of which are in fluid communication with the fluid supply passage of the fluid supply tube. Because the fluid is delivered to the fluid supply tube 18 under low pressure, a flexible fluid supply hose 56 can press on to the fitting 54 without the need for a complicated connection required to withstand a high pressure fluid connection. In other words, the fluid supply hose 56 can connect to the fluid supply tube via a press-on fit that can be accomplished without hand tools and without complicated latches. Moreover, since the fluid supply tube 56 does not need to be rigid to support a roller, which is typically not the case for an internally fed roller device, the fluid supply tube can be flexible and disposable, making cleanup much easier. A contour 58 can be formed in the shield 26 to accommodate the central hollow portion 52 and to allow for rotation of the fluid supply tube 18 with respect to the shield 26. If desired, the fluid supply tube 18 and the splatter shield 26 can be molded as a single integral piece made of, for example, plastic.

The handle 22 connects to the frame 16 at the central portion 28 of the splatter shield 26 and is rotatable with respect to the frame 16 in a handle pivot axis 60 that is spaced from each of the roller axes 44 and 46. In the depicted embodiment, the handle pivot axis 60 is located between the first roller axis 44 and the second roller axis 46 and is spaced normal to a plane in which both the first roller axis and the second roller axis reside. Accordingly, the handle pivot axis 60 is offset from each of the roller axes 44, 46 in two mutually perpendicular directions. This direct connection between the handle 22 and the splatter shield 26 allows the handle 22 to pivot with respect to the splatter shield 26 during painting, or applying fluid to a surface. This is not the case in known internally fed applicator devices, which can result in the splatter shield contacting the work surface during painting.

The handle 22 generally includes a distal forked end portion 62, a central portion 64 and a proximal hand grip portion 66. Posts 68 (only one visible in FIG. 2) are received in respective openings 72 (only one visible in FIG. 2) formed in the central portion 28 of the splatter shield 26 to provide the pivotal connection between the handle 22 and the frame 16. If desired, the central portion 28 of the splatter shield 26 can be formed with posts that are received in openings in the forked ends 62 of the handle 22. The central portion 64 is a hollow cylindrical member to provide a fluid path, if desired. As will be described below, the central portion 64 can also have a U-shaped configuration in a cross section normal to a longitudinal axis of the central portion. The hand grip portion 66 connects to an opposite end of the central portion 64 as the forked end 62. The hand grip portion 66 provides a location at which an operator of the applicator device 12 can grip the device.

The trigger 24 connects to the handle 22 near the hand grip portion 66. The trigger 24 pivotally attaches so that the trigger can be squeezed by the operator of the applicator device 12. The trigger 24 controls the flow of fluid through the fluid flow path of the fluid applicator assembly 10. The trigger 24 can operate a valve (not shown) to control the flow of fluid through the fluid flow path. The trigger can also be a button.

With reference to FIG. 3, which is a schematic depiction of the applicator device 12, the trigger 24 can also be configured to mechanically operate a pneumatic piston 80 (or bellows) that connects to a fitting 82 that is located at a proximal end 84 (FIG. 2) of the handle 22 via a pneumatic tube 86. The fitting 82 is also in communication with the fluid supply tube 18 through the fluid line 56 and the hollow central portion 64 of the handle 22, if desired. The fluid line 56 can extend through the handle 22 to the fitting 82 (the handle may be U-shaped or have a larger internal diameter than the fluid line 56 that the handle will receive), or the fluid supply line can connect to a fitting located where the central portion of the handle 64 joins the forked end 62 and the central portion of the handle can be hollow between the fluid supply line 56 and the fitting 82. The fitting 82 can be removable from the handle 22 so that the fitting can be easily transported to a sink for cleaning. The fitting 82 can also be a disposable item that is thrown away (along with the fluid line 56) when the liquid that is being applied with the applicator assembly is changed.

The fitting 82 provides for a connection between the applicator device 12 and a main supply hose 90 that interconnects the applicator device and the pumping device 14. The main hose 90 includes a fluid passage 92 and a pneumatic passage 94. Further discussion of the fluid passage and the pneumatic passage will be provided below. The main supply hose 90 in the depicted embodiment is a coextruded hose (see also FIG. 4) having two passages. Alternatively, two separate hoses, e.g. a fluid hose and pneumatic hose, can be provided.

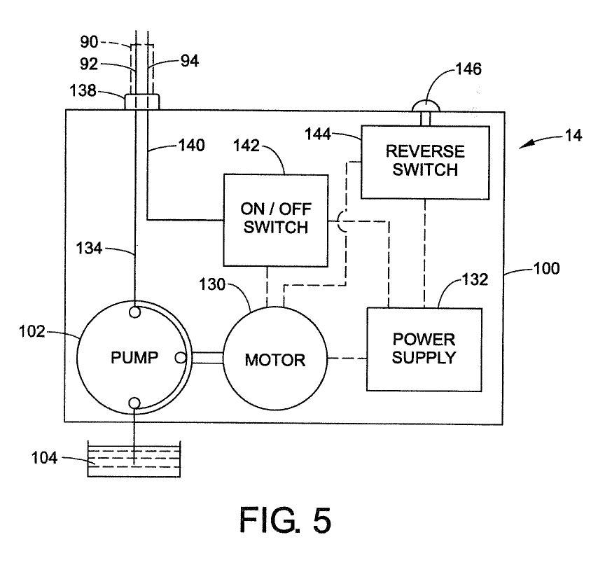

With reference to back FIG. 1, the pumping device 14 includes hosing 100 and a pump 102 (depicted schematically in FIG. 5) for pumping fluid, e.g. paint, from a reservoir 104, which in the example depicted in FIG. 1 is a conventional one-gallon paint can. The pumping device 14 can also be used to deliver paint from a reservoir, e.g. a five-gallon bucket, that is located remotely from the housing 100, albeit a longer fluid line connecting the larger reservoir and the pumping device 14 may be required.

The housing 100 includes a cylindrical receptacle 106 that has a diameter that is slightly larger than the diameter of a conventional one-gallon paint can. Alternatively, the receptacle can take other configurations, e.g. box-shaped, to accommodate differently configured reservoirs of liquid that is to be applied by the applicator. In addition to the paint can receptacle 106, the housing 100 also includes accessory receptacles 108 (one of the accessory receptacles is not visible in FIG. 1) that are configured to receive handles for paint brushes and other implements useful in painting and fluid application. FIG. 1 depicts a paint brush 110 with its handle (not visible) disposed in an accessory receptacle (not visible). The paint brush 110 can be an internally fed paint brush that can receive paint from the reservoir 104 through the main supply hose 90 when the roller applicator device 12 has been removed from the main supply hose and the paint brush has been connected to the main supply hose.

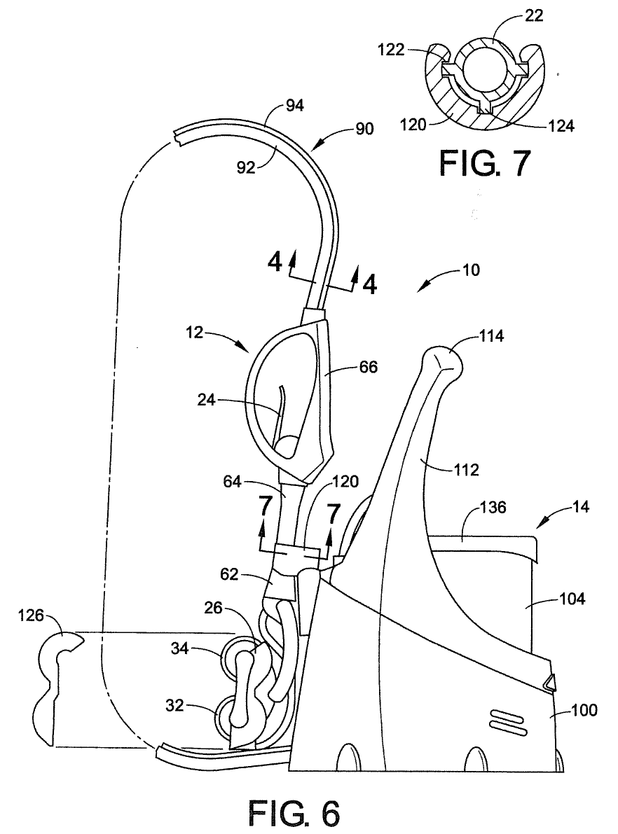

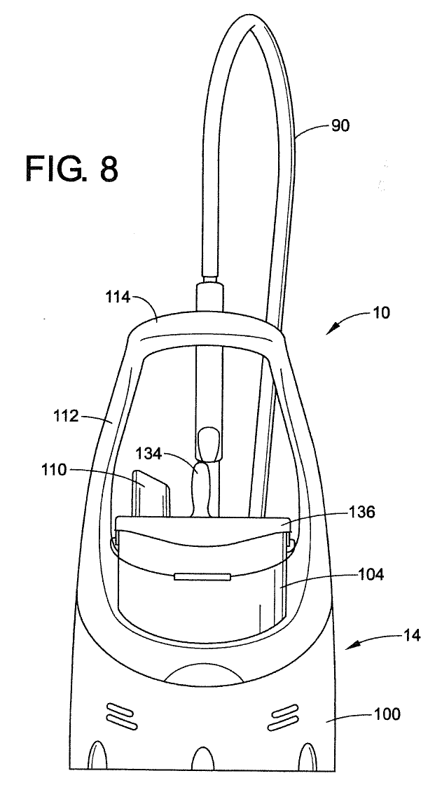

A handle 112 extends from the housing 100 above the reservoir receptacle 106 and the accessory receptacles 108. The handle 112 includes a hand grip portion 114 that can be grasped by an operator of the fluid applicator assembly 10 for moving the pumping device 14 from one location to another. A handle hanger 120 (see also FIG. 6) extends from an exterior of the housing 110 to provide a location for hanging the applicator device 12 from the pumping device housing 100. With reference to FIG. 7, the handle hanger 120 includes a U-shaped portion having a plurality of slots 122 that cooperate with ridges 124 formed on the handle 22 to align the applicator device 12 such that the exposed surfaces of the rollers 32 and 34 face away from the housing 100 as shown in FIG. 6. A cover 126 is provided to latch onto the splatter shield 26 to cover the rollers when not in use. The cover 126 and the splatter shield 26 can prevent the rollers 32 and 34 from drying out.

With reference back to FIG. 5, the pumping device 14 generally includes the pump 102 that is operated by a motor 130. The motor 130 in the depicted embodiment is a reversible electrical motor that is in electrical communication with a power supply 132, which in the depicted embodiment is an AC to DC converter that is able to convert 120 or 240 VAC (where the pumping device includes a plug that is to be inserted into an electrical receptacle) to a desired voltage and amperage for driving the motor. Alternatively, the power supply 132 could comprise a plurality of batteries or a single battery that can operate the motor.

The pump 102 can be any fluid pump capable of pumping the fluid that is to be applied by the fluid applicator assembly. Examples of such pumps includes impeller pumps and piston pumps. In the embodiment shown in the attached figures, the pump is a peristaltic pump, which eases clean up when changing the fluid, e.g. paint, that is being dispensed through the fluid applicator assembly.

As depicted schematically in FIG. 5, a single flexible hose 134 (see also FIG. 1) can be inserted into the reservoir 104 through an opening in a lid 136 that covers the paint can and be fed through the peristaltic pump 102 (rollers depicted schematically) and attached to a fitting 138 that acts as an outlet for the pumping device 14. The main hose 90 connects to this fitting 138 to deliver the fluid from the reservoir 104 to the applicator device 12. The fitting 138 can be removed from the housing 100 to be cleaned when the fluid in the reservoir 104, or the fluid in the reservoir, is changed. When a painting operation is finished, or when the fluid in the reservoir is to be changed, the flexible fluid line 134 can be removed from the pump 102 and the main line 90 can be removed from the fittings 138 and 82. The handle fluid line 56 can be removed from the fitting 82 and the fluid supply tube 18. The flexible tubes 134, 90 and 56 can be discarded and the fittings 138 and 82 can be cleaned or discarded. Likewise, the fluid supply tube 18 can also be flushed or discarded. By making the fitting 82 removable from the handle 12 and the fitting 138 removable from the housing 100, these fittings can be easily transported to a sink and flushed with water. If desired, the flexible line 134 that travels through the peristaltic pump 102 can also be inserted into water to flush the lines 134, 92 and 56. Moreover, the handle fluid supply line 56 has an end that attaches directly to the fluid supply tube 18 (as opposed to traveling through the handle and a rigid tube that is coaxial with the rotational axis of the upper roller 32) which allows the fluid supply line to be discarded when the painting operation is finished limiting the cleanup to the fluid supply tube 18, which can be easily cleaned because of its large diameter, and the hollow handle portion 22 (if the fluid contacts the inner surface thereof). Accordingly, a disposable fluid path assembly is provided so that many of the components of the assembly, e.g. the pump 102 and the internal surface of the handle 22, do not contact the fluid that is being applied, which greatly reduces clean up time as well as the water and other solvents that are required when cleaning internally fed roller devices.

As discussed above, the trigger 24 (FIG. 2) controls the delivery of fluid to the rollers 32 and 34. With reference to FIG. 5, the pneumatic line 94 of the main hose 90 fits onto the fitting 138 (a separate fitting can be provided to separate the fluid line from the pneumatic line) and communicates with a pneumatic line 140 in the housing 100 to operate a pneumatic on/off switch 142 to control the delivery of power to the motor 130. Other types of remove actuation such as an RF transmitter/receiver assembly can also be provided. Such a configuration may require a power source in the handle 22. Likewise, the switch 142 could be located in the handle if desired; however, electrical wires may need to be run between the applicator device 12 and the pumping device 14.

The pumping device 14 also includes a reverse switch 144 that is operated by a button 146 on the housing 100 and in electrical communication with the power supply 132 and the motor 130. The reverse switch 144, which can be a polarity switch, allows the pump 102 to operate in a first operating state where the pump delivers fluid to the applicator device 12 and in a second operating state where the pump draws fluid from the applicator device towards the reservoir 104. The reverse switch 144 reverses the rotation of the motor 130 so that the pump 102 operates to draw fluid from the applicator device 12 into the reservoir 104, which can be useful when a painting operation is completed. The reverse switch button 146 is located on the pumping device housing 100 remote from the handle to avoid the confusion that may result if a reverse switch were found on the handle.

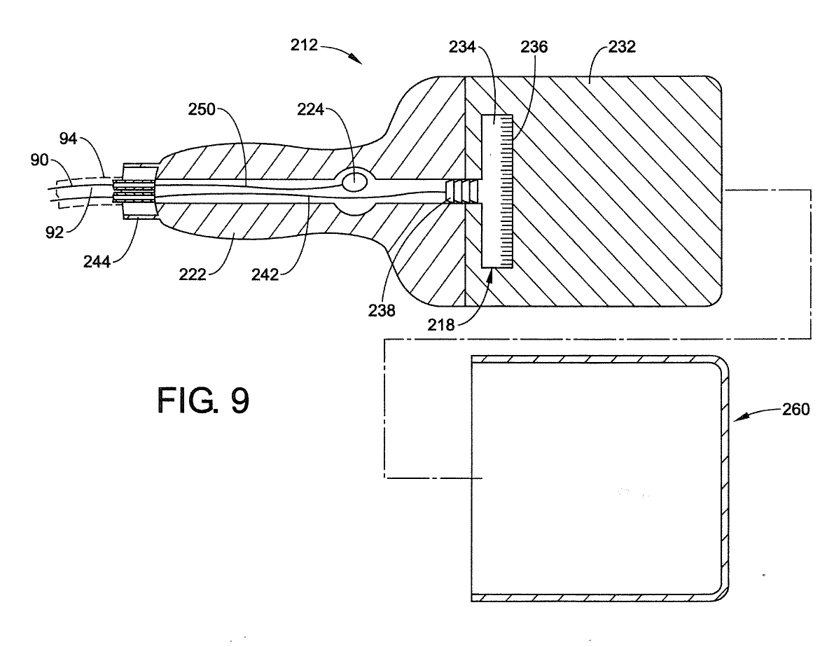

With reference to FIG. 9, an alternative embodiment of a fluid applicator 212, which can be particularly useful to cut in edges prior to using the roller applicator 12 (FIG. 2), can also be provided with the assembly 10. The fluid applicator 212, which looks similar to a conventional paint brush, includes a fluid supply tube 218, a handle 222 and a trigger 224. Bristles 232 (depicted schematically in cross section in FIG. 9) extend away from the handle. The bristles can have a circular, a rectangular or other configuration in a cross section taken normal to the direction in which the bristles extend from the handle.

The handle 222 is similar to the handle of a conventional paint brush except that it includes an internal passage for receiving a fluid supply hose 256, which is in fluid communication with the pumping device 14 (FIG. 1). The handle 222 can be configured to be received by the handle hanger 120 in much the same manner as the handle 22 of the roller applicator 12. Accordingly, the handle 222 for the paint brush applicator can include ridges (not depicted) much the same as the ridges 124 found on the handle 22 of the roller assembly.

The fluid supply tube 218 is similar in function to the fluid supply tube 18, described above, in that the fluid supply tube 218 provides fluid to an application surface, e.g. the distal ends of the bristles 232. The fluid supply tube 218 differs from the fluid supply tube 18, described above, in that the fluid supply tube is internally disposed within the bristles 232. The fluid supply tube 218 defines an internal passage 234 extending in a direction perpendicular to the direction in which the bristles extend. This configuration provides an even distribution of fluid over the application surface of the bristles. The fluid supply tube 218 includes a plurality of openings 236. The fluid supply tube 218, at least the portion that defines the transverse passage 234, can be made from a flexible material which allows the openings 236 to open when fluid is being pumped through the transverse passage and close when the fluid pressure across the openings 236 does not exceed a predetermined threshold value.

The fluid supply tube 218 also includes a fitting, which in the depicted embodiment is a press-on fitting 238, that is provided for connecting a tube 242 (depicted schematically), which can be flexible, to provide a fluid connection between the fluid supply tube and the fluid source. As depicted, the flexible tube 242 connects to a distal fitting 244 at an end opposite the end that attaches to the press-on fitting 238 of the fluid supply tube 218. The main hose 90 can also attach to the distal fitting 244 to allow the fluid line 92 of the main hose 90 to supply fluid to the brush applicator 212. Both the fluid line 92 of the main line 90 and the internal fluid line 242 of the handle can press on to the distal fitting 244. Also, the distal fitting can be removed from the handle 222, preferably by a person without the use of hand tools, so that the fitting and the lines can be easily replaced when the fluid that is being fed to the brush applicator 212 is being changed.

The brush applicator 212 also includes the trigger 224, which in the depicted embodiment is a button, to control the flow of fluid to the bristles 232. In the depicted embodiment, the trigger 224 operates a bellows, or piston, which is in fluid communication with the pneumatic switch 142 (FIG. 5) via an internal pneumatic line 250 (depicted schematically in FIG. 9) through the distal fitting 244 and via the pneumatic line 94 of the main hose 90, which is connected to the fitting 244. If desired, the trigger 224 could also open and close a valve located in the fluid path between the pumping device 12 and the fluid supply tube 218. Also, the trigger 224 can operate an electrical switch other than through a pneumatic line, for instance a an electrical wire can be run between the pumping device 12 and the trigger 224, or the trigger can operate an RF transmitter, or similar transmitter, to send a wireless signal to a receiver on the pumping device 12 to control the operation of the pump.

A cover 260 can snap onto the handle 222 and cover the bristles 232. The cover can maintain the moisture in the bristles when the brush applicator 212 is not in use. The cover 260 can attach to the handle in a similar manner that the cover 126 attaches to the splatter shield 26.

The fitting 244, as does the fitting 82 (FIG. 5), allows for quick connection and disconnection of the main hose 90 to facilitate easy change over from the roller applicator 12 to the brush applicator 212. The shape of the handle 222 and the shape of the handle 22 allow the brush applicator 212 to be stored on the hanger 120 while the roller applicator 12 is in use and vice versa. The flexible fluid hoses throughout the devices, also referred to as lines, (flexible being the ability for a person to deform the hose without the aid of hand tools, and more specifically to deform, e.g. squeeze, the circumference of the hose to change its shape from circular to another shape and/or to bend the hose about a relatively small radius without the aid of hand tools and/or the ability for the hose to slide over a press-on fitting and deforming to seal over the press-on fitting), along with the fittings can be easily removed from the pumping device 14 and the applicator devices 12 and 212 making clean up very easy as compared to devices that have rigid tubes along the fluid path. If desired, a single continuous hose, which may or may not include multiple passages, can extend from the reservoir 104 to the fluid supply tube 18 or 218, e.g. the single hose would be fed into the peristaltic pump 102 and extend through or along the handle 22 or 222 and onto the fluid supply tube.

A fluid applicator has been described with particularity. Modifications and alterations will occur to those reading and understanding the preceding detailed description. The invention is not to be limited to only those embodiments disclosed. Instead, the invention is broadly defined by the appended claims and the equivalents thereof.

1. A fluid applicator assembly comprising:
an applicator device and a pumping device,
the applicator device including:
a frame including a splatter shield, a first roller mount and a second roller mount;
a first roller mounted to the first roller mount for rotation about a first roller axis;
a second roller mounted to the second roller mount for rotation about a second roller axis that is spaced from the first roller axis;
a fluid supply passage connected with the frame and including a fluid outlet arranged for dispensing fluid onto an external surface of at least one of the first and second rollers; and
a handle connected to the splatter shield and rotatable with respect to the splatter shield in a handle pivot axis that is offset from the first roller axis and the second roller axis;
the pumping device including:
a housing;
a pump disposed in the housing and in communication with the fluid supply passage.

2. The assembly of claim 1, wherein the handle axis is located between the first roller axis and the second roller axis and is offset from a plane in which the first roller axis and the second roller axis reside.

3. The assembly of claim 2, wherein the fluid passage and the splatter shield are a single integrally formed piece of plastic.

4. The assembly of claim 2, further comprising a cover selectively attached to the splatter shield for covering the rollers mounted on the roller mounts.

5. The assembly of claim 1, wherein the housing includes a paint can receptacle configured to receive a conventional one-gallon paint can and a handle having a hand grip portion disposed vertically above the paint can receptacle.

6. The assembly of claim 5, wherein the housing includes an accessory receptacle spaced from the paint can receptacle, the accessory receptacle configured to receive a handle of a paint brush.

7. The assembly of claim 5, further comprising a handle hanger on the housing, the handle hanger being configured to receive the handle when the handle is disposed generally vertically for storing the handle on the housing.

8. The assembly of claim 7, wherein each of the handle and the handle hanger include locating features for aligning the handle so that the frame is oriented in a predetermined direction with respect to the housing.

9. The assembly of claim 1, further comprising a flexible tube connected to the fluid supply passage and supported by the handle.

10. The assembly of claim 1, further comprising an electric reversible motor operatively connected to the pump and a reverse switch mechanism in electrical communication with the motor for reversing rotational direction of the motor.

11. The assembly of claim 10, further comprising a button on the housing for operating the reverse switch mechanism.

12. The assembly of claim 10, wherein the pump is a peristaltic pump.

13. The assembly of claim 12, further comprising a flexible tube for inserting into an associated paint can supported in the housing and contacting rollers of the peristaltic pump.

14. A fluid applicator assembly comprising:
an applicator device and a pumping device,
the applicator device including a fluid applicator tool including at least one of a roller, a brush and a pad, the applicator device also including a fluid supply passage for dispensing fluid onto an application surface of the fluid applicator tool;
the pumping device including,
a housing;
a pump disposed in the housing and in communication with the fluid supply passage;
an electric reversible motor for driving the pump;
a power supply in electrical communication with the motor;
a polarity switch in electrical communication with the motor and the power supply for reversing the polarity of electricity provided to the motor to allow the pump to be operated in a first operating state where fluid is delivered toward the fluid supply passage and in a second operating state where fluid is drawn away from the fluid supply passage.

15. The assembly of claim 14, further comprising a main supply hose connecting the applicator device and the pumping device, wherein the pumping device further includes a fitting and an internal hose connecting an outlet of the pump to the fitting, the fitting being connected to the main supply hose.

16. The assembly of claim 15, wherein the main supply hose includes a fluid line and a pneumatic line.

17. The assembly of claim 16, wherein the applicator device includes at least one of an internally fed paint brush and a roller assembly.

18. The assembly of claim 17, wherein the roller assembly comprises
a frame including a first roller mount in a first roller axis and a second roller mount in a second roller axis that is spaced from the first roller axis;
a first roller mounted to the first roller mount;
a second roller mounted to the second roller mount;
a fluid supply passage connected with the frame and including a fluid outlet arranged for dispensing fluid onto an external surface of at least one of the first and second rollers; and
a handle connected to the frame and rotatable with respect to the frame in a handle pivot axis.

19. The assembly of claim 18, wherein the handle pivot axis is offset from the first roller axis and the second roller axis.

20. A fluid applicator assembly comprising:
an applicator device, a pumping device and a fluid path assembly interconnecting the applicator device and the pumping device to provide a fluid path between the applicator device and an associated fluid reservoir that is in fluid communication with the pumping device via the fluid path assembly,
the applicator device including a fluid applicator tool including at least one of a roller, a brush and a pad, the applicator device also including a fluid supply passage having a plurality of openings for dispensing fluid onto an application surface of the fluid applicator tool;
the pumping device including,
a housing; and
a pump disposed in the housing;
the fluid path assembly including at least one hollow flexible tube connected to the fluid supply passage, the entire fluid path assembly being removable from the applicator device and the pumping device between the fluid supply passage and the associated reservoir.
